(19) United States
(12) Patent Application Publication
(10) Pub. No.: US 2024/0405712 A1
(43) Pub. Date: Dec. 5, 2024

(54) Motor Driving Device, Motor System and Vehicle

(71) Applicant: ROHM CO., LTD., KYOTO (JP)

(72) Inventors: Yohei TAKAYAMA, KYOTO (JP); Akio YOSHIDA, KYOTO (JP)

(21) Appl. No.: 18/677,987

(22) Filed: May 30, 2024

(30) Foreign Application Priority Data
Jun. 5, 2023 (JP) 2023-092380

(51) Int. Cl. H02P 29/028; H02P 25/18

(52) U.S. Cl. CPC H02P 29/028; H02P 25/18; H02P 2201/09

(57) ABSTRACT

The present disclosure provides a motor driving device. The motor driving device includes a control unit operable to output gate signals to gates of motor relays. The gate signals are inputted to a power relay control unit operable to switch whether to apply an output voltage to a gate of the power relay.

### TECHNICAL FIELD

The present disclosure relates to a motor driving device.

### BACKGROUND

Conventionally, there are motor driving devices for driving various motors. For example, a motor driving device that drives such as a brushless DC motor drives a motor by using a circuit referred to as a half bridge. The half bridge has a high-side transistor and a low-side transistor connected in series between an application end of a power supply voltage and an application end of ground potential.

### BRIEF DESCRIPTION OF THE DRAWINGS

FIG. 1 is a diagram of a configuration of a motor system of a comparison example.

FIG. 2 is a diagram of a configuration of a charging pump of a comparison example.

FIG. 3 is a diagram of a configuration of a part of a motor system according to a first embodiment.

FIG. 4 is a diagram of a configuration of a part of a motor system according to a second embodiment.

FIG. 5 is a diagram of a configuration of a part of a motor system according to a third embodiment.

FIG. 6 is a diagram of a configuration of a part of a motor system according to a fourth embodiment.

FIG. 7 is a diagram of a configuration of a part of a motor system according to a fifth embodiment.

FIG. 8 is a diagram of appearance of a configuration example of a vehicle mounted with a motor system.

### DETAILED DESCRIPTION OF THE EMBODIMENTS

Details of the exemplary embodiments of the present disclosure are described with reference to the accompanying drawings below.

### 1. Comparison Example

Before the embodiments of the present disclosure are described, a comparison example for the purpose of comparison is provided below. Issues can become more apparent with the description of the comparison example.

### <<Motor System>>

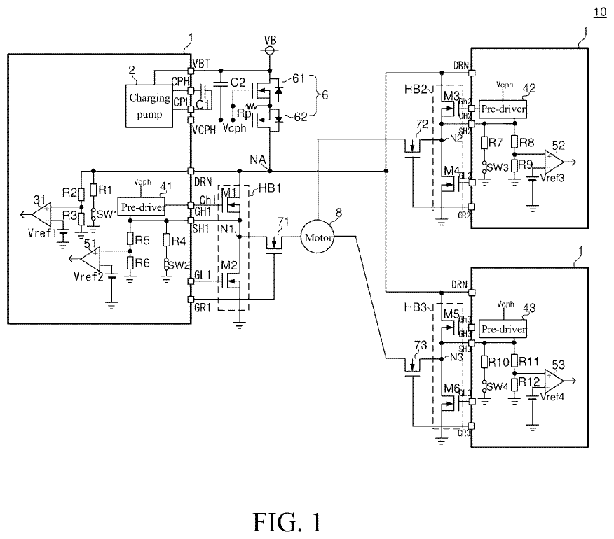

FIG. 1 shows a diagram of a configuration of a motor system 10 of a comparison example. The motor system 10 includes a motor driving device 1, half bridges HB1, HB2 and HB3, a power relay 6, a motor relays 71, 72 and 73, and a motor 8. The motor driving device 1 drives the motor 8 by the half bridges HB1, HB2 and HB3. The motor 8 is a three-phase brushless DC motor. Moreover, a motor as a driving target is not limited to being a brushless DC motor, and can be any motor such as a step motor or a brush DC motor operable to be driven by half bridges.

In the configuration in FIG. 1, three half bridges HB1, HB2 and HB3 are provided to correspond to the three-phase motor 8. The first half bridge HB1 includes an application terminal NA to which a power supply voltage VB is applicable when a power supply relay 6, which will be described later, is in an on state, a first high-side transistor M1 and a first low-side transistor M2 connected in series with a ground potential application terminal. More specifically, a drain of the first high-side transistor M1 formed by an N-channel metal-oxide-semiconductor field-effect transistor (MOSFET) is connected to the application end NA. A source of the first high-side transistor M1 is connected to a drain of the first low-side transistor M2 formed by an N-channel MOSFET at a first node N1. A source of the first low-side transistor M2 is connected to an application end of ground potential. Moreover, a current detection resistor can also be provided between the source of the first low-side transistor M2 and an application end of ground potential, and the same applies to the low-side transistors M4 and M6.

The second half bridge HB2 has a second high-side transistor M3 and a second low-side transistor M4 connected in series between the application end NA and an application end of ground potential. More specifically, a drain of the second high-side transistor M3 formed by an N-channel MOSFET is connected to the application end NA. A source of the second high-side transistor M3 is connected to a drain of the second low-side transistor M4 formed by an N-channel MOSFET at a second node N2. A source of the second low-side transistor M4 is connected to an application end of ground potential.

The third half bridge HB3 has a third high-side transistor M5 and a third low-side transistor M6 connected in series between the application end NA and an application end of ground potential. More specifically, a drain of the third high-side transistor M5 formed by an N-channel MOSFET is connected to the application end NA. A source of the third high-side transistor M5 is connected to a drain of the third low-side transistor M6 formed by an N-channel MOSFET at a third node N3. A source of the third low-side transistor M6 is connected to an application end of ground potential.

The first motor relay 71 is connected between the first node N1 and a U-phase input end of the motor 8. The second motor relay 72 is connected between the second node N2 and a V-phase input end of the motor 8. The third motor relay 73 is connected between the third node N3 and a W-phase input end of the motor 8. The motor relays 71, 72 and 73 can all be formed by N-channel MOSFETs.

Moreover, the motor relay can be formed by two N-channel MOSFETs. In this case, by connecting drains or sources of the two N-channel MOSFETs at a same node, body diodes of the two N-channel MOSFETs are connected in directions opposite to each other, hence preventing a reverse current.

The power reply 6 is connected between an application end of the power supply voltage VB and the application end NA. The power relay 6 includes a first N-channel MOSFET 61 and a second N-channel MOSFET 62. A drain of the first N-channel MOSFET 61 is connected to an application end of the power supply voltage VB. A source of the first N-channel MOSFET 61 is connected to a source of the second N-channel MOSFET 62. A drain of the second N-channel MOSFET 62 is connected to the application end NA. That is to say, the sources of the N-channel MOSFETs 61 and 62 are connected to each other at the same node. With the configuration of the power relay 6 above, the respective body diodes of the N-channel MOSFETs 61 and 62 are connected in directions opposite to each other, forming a configuration preventing a reverse current. Moreover, the configuration of the power relay 6 is not limited to the above, and the drains of the N-channel MOSFETs 61 and 62 can also be connected to each other at the same node. Moreover, the power relay 6 can also be formed by one N-channel MOSFET.

A pull-down resistor Rp is connected between the gates and the sources of the N-channel MOSFETs 61 and 62.

The motor driving device 1 is a semiconductor device integrated with the internal configurations shown in FIG. 1. The motor driving device 1 includes, as external terminals for asserting electrical connections with an outside, a terminal DRN (a drain terminal), a terminal GH1 (a first high-side gate terminal), a terminal SH1 (a first high-side source terminal), a GL1 terminal (a first low-side gate terminal), a terminal GH2 (a second high-side gate terminal), a terminal SH2 (a second high-side source terminal), a terminal GL2 (a second low-side gate terminal), a terminal GH3 (a third high-side gate terminal), a terminal SH3 (a third high-side source terminal) and a terminal GL3 (a third low-side gate terminal).

The terminal DRN is connected to the application end NA, that is, to the drains of the high-side transistors M1, M3 and M5. The motor driving device 1 includes resistors R1, R2 and R3, a switch SW1 and a comparator 31. The resistors R1, R2 and R3, the switch SW1 and the comparator 31 are operable to detect a short-circuit abnormality of the first N-channel MOSFET 61 in the power relay 6. The detection for the short-circuit abnormality is performed statically before the motor 8 is operated.

More specifically, the resistor R1 and the switch SW1 are connected between the terminal DRN and an application end of ground potential. The resistors R2 and R3 are connected in series between the terminal DRN and an application end of ground potential. A node to which the resistors R2 and R3 are connected is connected to a first input end of the comparator 31. A second input end of the comparator 31 is connected to an application end of a reference voltage Vref1.

The terminal GH1 is connected to the gate of the first high-side transistor M1. The motor driving device 1 further includes a pre-driver 41, resistors R4, R5 and R6, a switch SW2 and a comparator 51. A gate signal Gh1 output from the pre-driver 41 is applied to the gate of the high-side transistor M1 via the terminal GH1. Accordingly, driving for turning on and off the first high-side transistor M1 is performed. The pre-driver 41 turns on the first high-side transistor M1 by setting the gate signal Gh1 at a high level to an output voltage Vcph of the charging pump 2 described below. As to be described shortly, the output voltage Vcph is boosted by the charging pump 2 to a voltage higher than the power supply voltage VB, and so the first high-side transistor M1 implemented by an N-channel MOSFET can be turned on. On the other hand, the pre-driver 41 turns off the first high-side transistor M1 by setting the gate signal Gh1 at a low level to a voltage of the terminal SH1. The terminal SH1 is connected to the source of the first high-side transistor M1.

The terminal GL1 is connected to the gate of the first low-side transistor M2. By applying a gate signal output from the terminal GL1 to the gate of the first low-side transistor M2, driving for turning on and off the first low-side transistor M2 is performed.

The resistor R4 and the switch SW2 are connected between the terminal SH1 and an application end of ground potential. The resistors R5 and R6 are connected in series between the terminal SH1 and an application end of ground potential. A node to which the resistors R5 and R6 are connected is connected to a first input end of the comparator 51. A second input end of the comparator 51 is connected to an application end of a reference voltage Vref2.

The terminal GH2 is connected to the gate of the second high-side transistor M3. The motor driving device 1 further includes a pre-driver 42, resistors R7, R8 and R9, a switch SW3 and a comparator 52. Driving for turning on and off the second high-side transistor M3 is performed by a gate signal Gh2 output from the pre-driver 42 via the terminal GH2. The gate signal Gh2 has a high level as the output voltage Vcph, and a low level as the voltage at the terminal SH2. The terminal SH2 is connected to the source of the second high-side transistor M3.

The terminal GL2 is connected to the gate of the second low-side transistor M4. By applying a gate signal output from the terminal GL2 to the gate of the second low-side transistor M4, driving for turning on and off the second low-side transistor M4 is performed.

The resistor R7 and the switch SW3 are connected between the terminal SH2 and an application end of ground potential. The resistors R8 and R9 are connected in series between the terminal SH2 and an application end of ground potential. A node to which the resistors R8 and R9 are connected is connected to a first input end of the comparator 52. A second input end of the comparator 52 is connected to an application end of a reference voltage Vref3.

The terminal GH3 is connected to the gate of the third high-side transistor M5. The motor driving device 1 further includes a pre-driver 43, resistors R10, R11 and R12, a switch SW4 and a comparator 53. Driving for turning on and off the third high-side transistor M5 is performed by a gate signal Gh3 output from the pre-driver 43 via the terminal GH3. The gate signal Gh3 has a high level as the output voltage Vcph, and a low level as the voltage at the SH3 terminal. The terminal SH3 is connected to the source of the third high-side transistor M5.

The terminal GL3 is connected to the gate of the third high-low transistor M6. By applying a gate signal output from the terminal GL3 to the gate of the third low-side transistor M6, driving for turning on and off the third low-side transistor M6 is performed.

The resistor R10 and the switch SW4 are connected between the terminal SH3 and an application end of ground potential. The resistors R11 and R12 are connected in series between the terminal SH3 and an application end of ground potential. A node to which the resistors R11 and R12 are connected is connected to a first input end of the comparator 53. A second input end of the comparator 53 is connected to an application end of a reference voltage Vref4.

Moreover, the motor driving device 1 includes, as external terminals, a terminal GR1 (a first relay gate terminal), a terminal GR2 (a second relay gate terminal) and a terminal GR3 (a third relay gate terminal). The terminal GR1 is connected to a gate of the motor relay 71. The terminal GR2 is connected to a gate of the motor relay 72. The terminal GR3 is connected to a gate of the motor relay 73. Driving for turning on and off each of the motor relays 71, 72 and 73 is performed by a gate signal output from each of the terminal GR1, the terminal GR2 and the terminal GR3.

The motor system 10 is preferably provided with the power relay 6 and the motor relays 71 to 73 for such as the field of vehicles demanding functional safety. The power relay 6 switches to whether supply the power supply voltage VB to the half bridges HB1 to HB3. For example, when an abnormality is detected while the power reply 6 supplies the power supply voltage VB to the half bridges HB1 to HB3, the motor 8 can be changed from three-phase driving to two-phase driving by turning off any one of the motor relays 71 to 73. Moreover, when an abnormality is detected, the motor 8 can be stopped also by turning off the power relay 6 in a way that the power supply voltage VB supplied to the half bridges HB1 to HB3 is disconnected.

Moreover, the motor system 10 has the following functions: statically detecting a short-circuit/open-circuit abnormality of each of the transistors M1 to M6, and a short-circuit/open-circuit abnormality of the motor relays 71 to 73 before the motor 8 is operated. Such detection for short-circuit/open-circuit abnormalities can be performed based on output levels of the comparators 51 to 53 under a pattern set according to a combination of turning on and off the switches SW2 to SW4, turning on and off the transistors M1 to M6 and turning on and off the motor relays 71 to 73. Execution sequences are performed by switching such pattern.

### <<Charging Pump>>

The motor driving device 1 includes the charging pump 2. Corresponding to the charging pump 2, the motor driving device 1 includes, as external terminals, a terminal VCPH (an output terminal), a terminal CPL (a capacitor low-side terminal), a terminal CPH (a capacitor high-side terminal) and a terminal VBT (a power supply terminal). The charging pump 2 boosts the power supply voltage VB to generate and output the output voltage Vcph. The output voltage Vcph is output from the terminal VCPH, and is applied to the gate of each of the N-channel MOSFETs 61 and 62 in the power relay 6. Moreover, as described above, the output voltage Vcph is also supplied to the pre-drivers 41 to 43. The capacitor C1 is externally connected between the terminal CPH and the terminal CPL. The capacitor C2 is externally connected between the terminal VBT and the terminal VCPH.

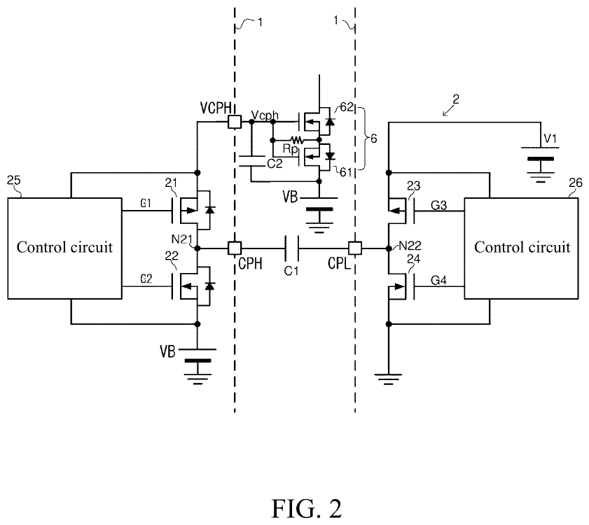

A configuration of the charging pump is described with reference to FIG. 2 below. The charging pump 2 shown in FIG. 2 includes transistors 21 to 24 and control circuits 25 and 26.

The transistor 21 is formed by a P-channel MOSFET. A source of the transistor 21 is connected to the terminal VCPH. The transistor 22 is formed by an N-channel MOSFET. A drain of the transistor 22 is connected to a drain of the transistor 21 at a node N21. A source of the transistor 22 is connected to an application end of the power supply voltage VB. The node 21 is connected to the terminal CPH.

The transistor 23 is formed by a P-channel MOSFET. A source of the transistor 23 is connected to an application end of a power supply voltage V1. The transistor 24 is formed by an N-channel MOSFET. A drain of the transistor 24 is connected to a drain of the transistor 23 at a node N22. A source of the transistor 24 is connected to an application end of ground potential. The node N22 is connected to the terminal CPL.

The control circuit 25 drives the transistors 21 and 22 by applying a driving signal G1 to the gate of the transistor 21 and applying a driving signal G2 to the gate of the transistor 22. The control circuit 25 generates the driving signal G1 by using the output voltage Vcph of the terminal VCPH as a reference, and generates the driving signal G2 by using the power supply voltage VB as a reference.

The control circuit 26 drives the third transistor 23 and the fourth transistor 24 by applying a driving signal G3 to the gate of the transistor 23 and applying a driving signal G4 to the gate of the fourth transistor 24. The control circuit 26 generates the driving signal G3 by using the power supply voltage V1 as a reference, and generates the driving signal G4 by using ground potential as a reference.

Before such type of charging pump 2 reaches operation stability, the transistors 22 and 24 are first turned on, the transistors 21 and 23 are turned off, and the power supply voltage VB is applied to the capacitor C1 for charging. Then, the transistors 22 and 24 are turned off and the transistors 21 and 23 are turned on, and accordingly the voltage of the terminal CPH is then VB+V1 and is output as the output voltage Vcph from the terminal VCPH. At this point in time, the capacitor C2 is charged. By repeating the operation above, the power supply voltage VB is boosted. The N-channel MOSFETs 61 and 62 can be turned on by applying the output voltage Vcph boosted from the power supply voltage VB to the gate of each of the N-channel MOSFETs 61 and 62. In this case, the power relay 6 is turned on, and supplies the power supply voltage VB to the half bridges HB1 to HB3. For example, when VB=48 V and V1=12 V, Vcph=48+12=60 V.

On the other hand, when the charging pump 2 is stopped, the transistors 21 to 24 are turned off. At this point in time, a current path formed from the application end of the power supply voltage VB, the body diode of the transistor 22, the body diode of the transistor 21, the terminal VCPH, the pull-down resistor Rp and the body diode of the second N-channel MOSFET 62 faces an issue of not being fully disconnected at the N-channel MOSFET 61.

In particular, in the configuration shown in FIG. 1, when detection for a short-circuit abnormality of the first N-channel MOSFET 61 is performed, the switch SW1 is turned on and an output level of the comparator 31 is determined. When there is no short-circuit abnormality in the first N-channel MOSFET 61, the voltage of the terminal DRN is VB−2Vf−Vth−1Vf=VB−3Vf−Vth. In the above, Vf is a forward voltage of each of the body diodes of the transistors 21 and 22 and the body diode of the second N-channel MOSFET 62, and Vth is a threshold voltage of the first N-channel MOSFET 61. On the other hand, when short-circuit abnormality is present in the first N-channel MOSFET 61, the voltage of the terminal DRN is VB−Vf. In the comparator 31, a minute difference between VB−3Vf−Vth and VB−Vf, that is, 2Vf−Vth, needs to be detected. However, since the N-channel MOSFET 61 in fact cannot be fully disconnected (that, it is weakly turned on), it is difficult to determine the voltage difference of the terminal DRN caused by presence or absence of a short-circuit abnormality. For example, VB=48 V, Vf=0.7 V, and Vth=1.2 V.

### 2. First Embodiment

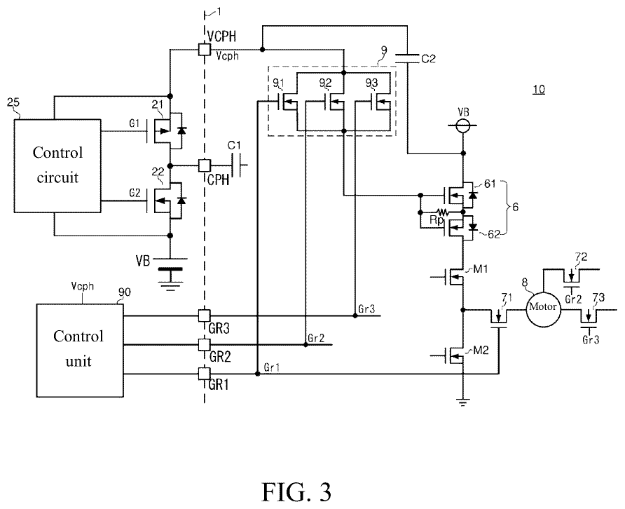

Details of the embodiments of the present disclosure are described below in view of the issues above. Difference from the configuration of the comparison example shown in FIG. 1 are primarily described herein. FIG. 3 shows a diagram of a configuration of a part of the motor system 10 according to a first embodiment. In this embodiment, a power relay control unit 9 is provided outside the motor driving device 1.

The power relay control unit 9 includes gate cutoff relays 91, 92 and 93. Three gate cutoff relays are provided to correspond to the three phases of the motor 8. The gate cutoff relays 91 to 93 are all formed by N-channel MOSFETs. The gate cutoff relays 91 to 93 are connected between the terminal VCPH and the gates of the N-channel MOSFETs 61 and 62 in the power relay 6. More specifically, respective drains of the gate cutoff relays 91 to 93 are commonly connected to the terminal VCPH. Respective sources of the gate cutoff relays 91 to 93 are commonly connected to the gates of the N-channel MOSFETs 61 and 62. That is to say, the gate cutoff relays 91 to 93 are connected in parallel.

Gates of the gate cutoff relays 91 to 93 are connected to the terminal GR1, the terminal GR2 and the terminal GR3, respectively. The motor driving device 1 further includes a control unit 90. The control unit 90 outputs gate signals Gr1, Gr2 and Gr3 from the terminal GR1, the terminal GR2 and the terminal GR3, respectively. As shown in FIG. 1, the terminal GR1, the terminal GR2 and the terminal GR3 are connected to the respective gates of the motor relays 71 to 73, respectively. Accordingly, each of the motor relays 71 to 73 is controlled to be turned on and off, and each of the gate cutoff relays 91 to 93 is controlled to be turned on and off by each of the gate signals Gr1 to Gr3. Thus, by sharing gate control lines of the motor relays 71 to 73 to control the power relay control unit 9 configured for controlling turning on and off the power relay 6, the power relay control unit 9 can be set to be an effective configuration, inhibiting an increase in the number of external parts.

The operation of the power relay control unit 9 is described herein below. At least any one of the gate signals Gr1 to Gr3 is set to a high level. The high level is the output voltage Vcph output from the charging pump 2. In this case, according to the gate signal set to a high level, at least any one of the motor relays 71 to 73 is turned on, and the voltage of the source of each of the gate cutoff relays 91 to 93 is Vcph−Vt. In the above, Vt is a threshold voltage of the gate cutoff relays 91 to 93. Thus, according to the gate signal set to a high level, at least any one of the gate cutoff relays 91 to 93 is turned on. Accordingly, the power relay control unit 9 is turned on, and the output voltage Vcph is supplied to the gates of the N-channel MOSFETs 61 and 62 via the power relay control unit 9. Hence, the power relay 6 is turned on.

On the other hand, all of the gate signals Gr1 to Gr3 are set to a low level. The low level is almost ground potential. In this case, the motor relays 71 to 73 are all turned off. At this point in time, the voltage of the source of each of the gate cutoff relays 91 to 93 is at ground potential, and all of the gate cutoff relays 91 to 93 are turned off. Accordingly, ground potential is applied to the gates of the N-channel MOSFETs 61 and 62. At this point in time, a current path through the pull-down resistor Rp is not formed, and the first N-channel MOSFET 61 is more reliably turned off. When there is no short-circuit abnormality in the first N-channel MOSFET 61, the voltage of the terminal DRN is at ground potential. Thus, a difference between the voltage of the terminal DRN, which is VB-Vth, and ground potential when a short-circuit abnormality is present in the first N-channel MOSFET 61 is larger, and it is then easily to detect a short-circuit abnormality by using the comparator 31.

Thus, in this embodiment, the power relay control unit 9 is turned on when at least any one of the gate signals Gr1 to Gr3 is at a high level, and is turned off when all of the gate signals Gr1 to Gr3 are at a low level and functions as an OR relay. Because there is almost no need for the motor 8 to operate when all of the motor relays 71 to 73 are turned off, the power relay 6 is turned off to disconnect the supply of the power supply voltage VB by turning off the power relay control unit 9.

Moreover, when only one half bridge and only one motor relay are provided, it is feasible to provide only one gate cutoff relay in the power relay control unit. That is to say, the power relay control unit is not limited to being an OR relay.

### 3. Second Embodiment

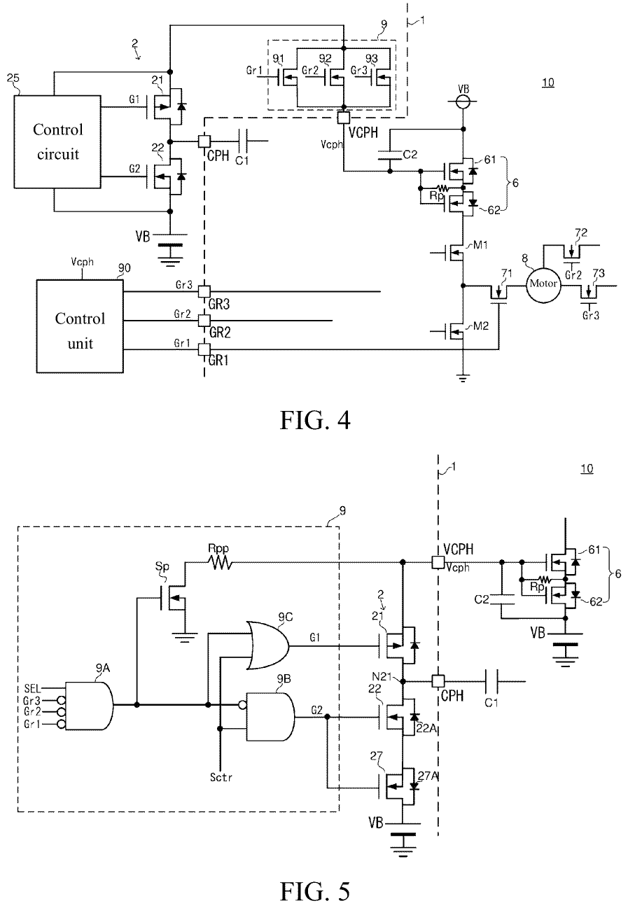

FIG. 4 shows a diagram of a configuration of a part of the motor system 10 according to a second embodiment. A difference of this embodiment from the first embodiment is that, the power relay control unit 9 is built in the motor driving device 1.

In this embodiment shown in FIG. 4, the respective drains of the gate cutoff relays 91 to 93 in the power relay control unit 9 are commonly connected to the source of the transistor 21 in the charging pump 2. The respective sources of the gate cutoff relays 91 to 93 are commonly connected to the terminal VCPH. That is to say, the gate cutoff relays 91 to 93 are connected between the source of the transistor 21 (the output end of the charging pump 2) and the terminal VCPH.

According to this embodiment, the power relay control unit 9 functions as an OR relay same as the first embodiment, and can control turning on and off of the power relay 6. In particular, in this embodiment, an increase in external parts can be further suppressed. However, in this embodiment, when the transistor 21 is turned on, a current flows through the power relay control unit 9 and the terminal VCPH to charge the capacitor C2. Thus, considering the influences of an on resistance of the power relay control unit 9 on a current ability, attention needs to be paid to the design of the current ability.

### 4. Third Embodiment

FIG. 5 shows a diagram of a configuration of a part of the motor system 10 according to a third embodiment. In this embodiment, in the charging pump 2, a transistor 27 which is an N-channel MOSFET is added to the transistor 22 which is an N-channel MOSFET. Moreover, the power relay control unit 9 is configured differently from the first and second embodiments. In this embodiment, the power relay control unit 9 is built in the motor driving device 1.

In the configuration shown in FIG. 5, a source of the transistor 27 and the source of the transistor 22 are connected at a same node. A drain of the transistor 27 is connected to an application end of the power supply voltage VB. Accordingly, a body diode 22A of the transistor 22 and a body diode 27A of the transistor 27 are connected in directions opposite to each other. Thus, when the transistors 27, 22 and 21 are turned off, a reverse current from an application end of the power supply voltage VB is blocked by the body diode 27A, preventing the VB−2Vf voltage from being applied to the terminal VCPH.

In the configuration shown in FIG. 5, the power relay control unit 9 includes an AND circuit 9A, an AND circuit 9B, an OR circuit 9C, a pull-down switch Sp and a pull-down resistor Rpp. The gate signals Gr1 to Gr3 are inverted and input to the AND circuit 9A, and a selection signal SEL is further input to the AND circuit 9A. The AND circuit 9A outputs a logical product of the inputs. An inverted signal of an output of the AND circuit 9A and a control signal Sctr are input to the AND circuit 9B. An output of the AND circuit 9B is applied to the gates of the transistors 22 and 27. An output of the AND circuit 9A and the control signal Sctr are input to the OR circuit 9C. An output of the OR circuit 9C is applied to the gate of the transistor 21. Moreover, the output of the AND circuit 9A is applied to a gate of the pull-down switch Sp formed by an N-channel MOSFET. A source of the pull-down switch Sp is connected to an application end of ground potential. A drain of the pull-down switch Sp is connected to the terminal VCPH via the pull-down resistor Rpp. Moreover, the pull-down resistor Rpp is optional.

Herein, the selection signal SEL is set to a high level. When at least any one of the gate signals Gr1 to Gr3 is at a high level, the output of the AND circuit 9A is at a low level and the pull-down switch Sp is turned off. At this point in time, the output of the AND circuit 9B corresponds to a level of the control signal Sctr. Such mode is a first mode of the power relay control unit 9.

The AND circuit 9B has a function of level shifting the level of the control signal Sctr. For example, when the power supply voltage VB=48 V and the control signal Sctr=0 V (a low level), 0 V is level shifted to 48 V, and a 48-V output signal is output as a low level. On the other hand, for example, when the control signal Sctr=5 V (a high level), 5 V is level shifted to 48 V, and a 48 V+5 V-output signal is output as a high level.

When the control signal Sctr is at a low level, the output of the AND circuit 9B (=the gate signal G2) is at a low level. For example, when VB=48 V, the output of the AND circuit 9B is 48 V, and both of the transistors 22 and 27 are turned off. In this case, an output of the OR circuit 9C, that is, the gate signal G1 of the transistor 21, is set to a low level, the transistor 21 is turned on, and the voltage (=V1+VB) of the terminal CPH is output as the output voltage Vcph from the terminal VCPH. For example, the voltage of the terminal CPH is V1+VB=12 V+48 V=60 V, and G1=60 V−5 V.

On the other hand, when the control signal Sctr is at a high level, the output of the AND circuit 9B (=the gate signal G2) is at a high level. For example, when VB=48 V, the output of the AND circuit 9B is 48 V+5V, and both of the transistors 22 and 27 are turned on. In this case, the gate signal G1 of the transistor 21 is at a high level (=the voltage of the terminal VCPH), the transistor 21 is turned off, and the voltage of the terminal CPH is VB. At this point in time, for example, the voltage of the terminal VCPH is 60 V, and G1=60 V.

Thus, when the selection signal SEL is at a high level and at least any one of the gate signals Gr1 to Gr3 is at a high level, a boost operation of the charging pump 2 is performed by switching of the control signal Sctr.

On the other hand, when the selection signal SEL is at a high level and all of the gate signals Gr1 to Gr3 are at a low level, the output of the AND circuit 9A is at a high level and the pull-down switch Sp is turned on. At this point in time, the output of the AND circuit 9B (=the gate signal G2) is at a low level regardless of the control signal Sctr, and both of the transistors 22 and 27 are turned off. Such mode is a second mode of the power relay control unit 9. With the pull-down switch Sp, the voltage of the terminal VCPH is 0 V. At this point in time, the gate signal G1 is at a high level (=the voltage of the terminal VCPH), and the transistor 21 is turned off. Accordingly, the first N-channel MOSFET 61 can be more reliably turned off by applying 0 V to the gate of the first N-channel MOSFET 61.

According to this embodiment, since respective gate control lines of the motor relays 71 to 73 are shared to control the power relay control unit 9, the power relay control unit 9 can be set to be an effective configuration. Moreover, when at least any one of the gate signals Gr1 to Gr3 is at a high level, that is, when at least any one of the motor relays 71 to 73 is turned on, the power relay 6 is turned on by the boost operation of the charging pump 2; when all of the gate signals Gr1 to Gr3 are at a low level, that is, when all of the motor relays 71 to 73 are turned off, the power relay 6 can be turned off.

Moreover, when the selection signal SEL is at a low level, the output of the AND circuit 9A is at a low level, and the pull-down switch Sp is turned off. At this point in time, the output of the AND circuit 9B and the output of the OR circuit 9C correspond to the level of the control signal Sctr, the boost operation of the charging pump 2 can be performed, and the power relay 6 is turned on. In this case, since the power relay 6 can be turned on regardless of the levels of the gate signals Gr1 to Gr3, when all of the gate signals Gr1 to Gr3 are at a low level, that is, when all of the motor relays 71 to 73 are turned off, the power relay 6 can be turned on.

Accordingly, various patterns for statically detecting a short-circuit/open-circuit abnormality can be implemented. For example, in FIG. 1, the switch SW2 is turned on, the switches SW3 and SW4 are turned off, all of the transistors M1 to M6 are turned off, all of the motor relays 71 to 73 are turned off, and the power relay 6 is turned on. In this pattern, detection for short-circuit abnormalities of the transistors M1, M4 and M6 can be performed.

Moreover, in this embodiment, when the transistor 27 which is an N-channel MOSFET is added, the drains of the transistors 22 and 27 can be connected at the same node. Moreover, provided that it is logically equivalent, the AND circuit 9A can also be represented by MIL logic symbols such as a NAND circuit or an OR circuit.

### 5. Fourth Embodiment

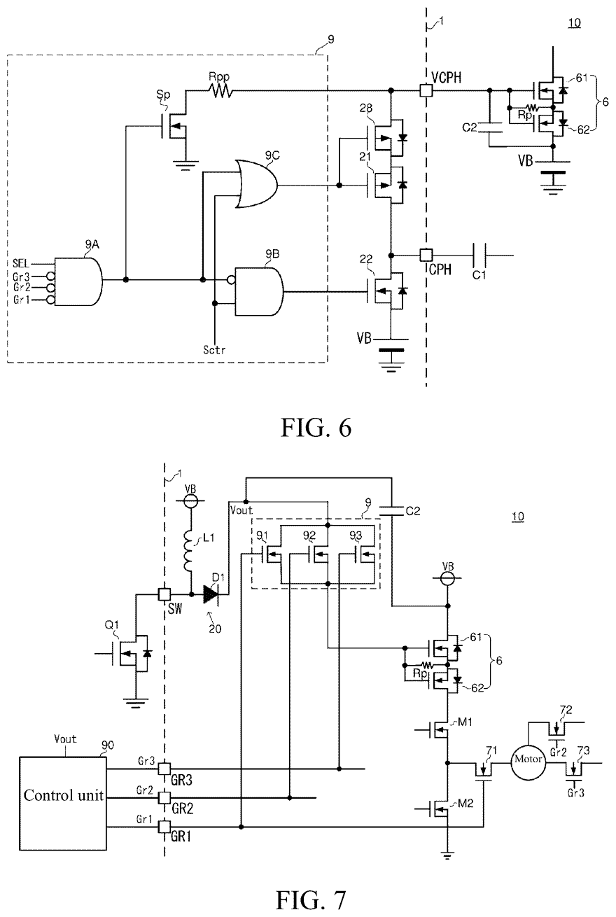

FIG. 6 shows a diagram of a configuration of a part of the motor system 10 according to a fourth embodiment. In this embodiment, a difference from the third embodiment is that, a transistor 28 which is a P-channel MOSFET is added for the transistor 21. Sources of the transistors 21 and 28 are connected at a same node. Thus, respective body diodes of the transistors 21 and 28 are connected in directions opposite to each other, and when the transistors 21, 22 and 28 are turned off, a reverse current from an application end of the power supply voltage VB can be prevented. Moreover, drains of the transistors 21 and 28 can also be connected at a same node. However, when the sources of the transistors 21 and 28 are connected at the same node, only one gate-source protection element (not shown) is needed in between.

### 6. Fifth Embodiment

FIG. 7 shows a diagram of a configuration of a part of the motor system 10 according to a fifth embodiment. This embodiment differs from the first embodiment (FIG. 3) in that, a boost DC/DC converter 20 is used in substitution for a charging pump as a booster circuit.

The boost DC/DC converter 20 boosts the power supply voltage VB to generate an output voltage Vout. The boost DC/DC converter 20 includes an inductor L1, a diode D1 and a switch element Q1. The inductor L1 and the diode D1 are disposed outside the motor driving device 1. A first end of the inductor L1 is connected to an application end of the power supply voltage VB. A second end of the inductor L1 is connected to an anode of the diode D1. The motor driving device 1 includes a terminal SW (a switch terminal) as an external terminal. The terminal SW is connected to the second end of the inductor L1. The switch element Q1 is built in the motor driving device 1, and is formed by an N-channel MOSFET. A drain of the switch element Q1 is connected to the terminal SW. A source of the switch element Q1 is connected to an application end of ground potential.

By performing driving for turning on and off the switch element Q1, the output voltage Vout is generated at a cathode of the diode D1. The power relay control unit 9 is connected between an application end of the output voltage Vout and the power relay 6.

When at least any one of the gate signals Gr1 to Gr3 is at a high level (=Vout), at least any one of the gate cutoff relays 91 to 93 in the power relay control unit 9 is turned on, and the power relay 6 (the N-channel MOSFETs 61 and 62) is turned on.

### 7. Number of Half Bridges

A three-phase motor is used in the embodiments described above, and so the number of half bridges is three; however, the present disclosure is not limited to the example above. For example, a motor system including two half bridges configured as an H-bridge can also be used to drive a brush DC motor. Alternatively, for example, a motor system including one bridge can also be used to drive a brush DC motor. Moreover, multiple half bridges can also be provided, and a motor is provided according to each half bridge.

### 8. Application in Vehicle

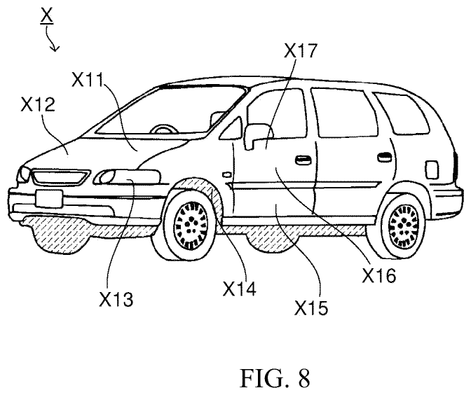

FIG. 8 shows a diagram of appearance of a configuration example of a vehicle mounted with the motor system 10 described above. In FIG. 8, as application examples of the motor 8, various motors X11 to X17 mounted in a vehicle X are shown. The motor system 10 is suitable in particularly for vehicles demanding functional safety.

X11 is a motor for electric power steering. X12 is a motor for electric oil pump. X13 is a motor for driving headlights. X14 is a motor for electric parking brakes. X15 is a motor for seat cooling fans. X16 is a motor for opening and closing door. X17 is a motor for door locks.

### 9. Other

Further, in addition to the embodiments, various modifications may be applied to the technical features disclosed by the present disclosure without departing from the scope of the technical inventive subject thereof. That is to say, all aspects of the embodiments are exemplary and should not be construed as limitations, and the technical scope of the present disclosure is not limited to the embodiments but should be understood as including all modifications equivalent to meanings of the claims within the scope.

### 10. Notes

As described above, for example, a motor driving device (1) according to an aspect of the present disclosure is configured to be applied to a motor system (10), the motor system (10) comprising:
at least one half bridge (HB1, HB2, HB3), including a high-side transistor (M1, M3, M5) and a low-side transistor (M2, M4, M6) connected in series between an application end of a power supply voltage (VB) and an application end of ground potential, and operable to connect a motor (8) to a node (N1, N2, N3) to which the high-side transistor and the low-side transistor are connected;
a power relay (6), connected between the application end of the power supply voltage and the high-side transistor, and including one or more N-channel MOSFETs (61, 62);
a motor relay (71, 72, 73), connected between the node and the motor, and including one or more N-channel MOSFETs; and
a booster circuit (2), operable to boost the power supply voltage to generate an output voltage (Vcph),
wherein the motor driving device (1) includes a control unit (90) operable to output a gate signal (Gr1, Gr2, Gr3) to a gate of the motor relay, and
the gate signal is inputted to a power relay control unit (9) operable to switch whether to apply the output voltage to a gate of the power relay (a first configuration).

Moreover, the first configuration can be configured that, the power relay control unit (9) includes one or more gate cutoff relays (91, 92, 93) connected between an application end of the output voltage (Vcph) and the gate of the power relay (6), and
the gate signal is applicable to a gate of the gate cutoff relay (a second configuration).

Moreover, the second configuration can be configured that, the power relay control unit (9) includes two or more of the gate cutoff relays (91, 92, 93) connected in parallel (a third configuration).

Moreover, the second or third configuration can be configured as comprising:
an output terminal (a terminal VCPH), as an external terminal operable to output the output voltage (Vcph), wherein a capacitor (C2) is connected between the output terminal and the application end of the power supply voltage (VB), and the gate cutoff relay (91, 92, 93) is externally connected to the output terminal (a fourth configuration).

Moreover, the fourth configuration can be configured that, the booster circuit is a charging pump (2) (a fifth configuration).

Moreover, the second configuration can be configured as comprising:
an output terminal (a terminal VCPH), as an external terminal,
wherein the power relay control unit (9) is built in the motor driving device (1), and the gate cutoff relay (91, 92, 93) is connected between an output end of the booster circuit (2) and the output terminal (a sixth configuration).

Moreover, the first configuration can be configured as comprising:
an output terminal (a terminal VCPH), as an external terminal operable to output the output voltage (Vcph), the booster circuit is a charging pump (2), wherein the booster circuit includes:
   a first transistor (21) and a second transistor (22) connected between the output terminal and the application end of the power supply voltage (VB); and
   a third transistor (27) including a diode (27A) connected in a direction opposite to an anti-parallel diode (22A) of the first transistor or the second transistor,
the power relay control unit (9) includes a pull-down switch (Sp) operable to pull down the output terminal to ground potential,
the power relay control unit is operable to switch between a first mode and a second mode according to the gate signal (Gr1, Gr2, Gr3),
the first mode is a mode in which the pull-down switch is turned off, and the first transistor, the second transistor and the third transistor are turned on or off according to switching of a control signal (Sctr), and
the second mode is a mode in which the pull-down switch is turned on, and the first transistor, the second transistor and the third transistor are turned off regardless of the control signal (a seventh configuration).

Moreover, the seventh configuration can be configured that, the first transistor (21) includes a P-channel MOSFET, the second transistor (22) includes an N-channel MOSFET, the third transistor (27) includes an N-channel MOSFET, and sources or drains of the second transistor and the third transistor are connected at the same node (an eighth configuration, FIG. 5).

Moreover, the seventh configuration can be configured that, the first transistor (21) includes a P-channel MOSFET, the second transistor (22) includes an N-channel MOSFET, the third transistor (28) includes a P-channel MOSFET, and sources or drains of the first transistor and the third transistor are connected at the same node (a ninth configuration, FIG. 6).

Moreover, any one of the seventh to ninth configurations can be configured that, the motor relay (71, 72, 73) is disposed in a number of two or more, when at least one of the gate signals (Gr1, Gr2, Gr3) is at a high level, the power relay control unit is in the first mode, and when all the gate signals are at a low level, the power relay control unit is in the second mode (a tenth configuration).

Moreover, the tenth configuration can also be configured that, when a selection signal (SEL) is at a predetermined level, the power relay control unit enters the first mode regardless of the gate signal (an eleventh configuration).

Moreover, a motor system (10) according to an aspect of the present disclosure, comprises:
the motor driving device (1) of any one of the first to eleventh configurations, the half bridge (HB1, HB2, HB3), and the motor (8) (a twelfth configuration).

Moreover, a vehicle (X) according to an aspect of the present disclosure is configured to include the motor system (10) of the twelfth configuration (a thirteenth configuration).

### INDUSTRIAL APPLICABILITY

The present disclosure can be, for example, implemented in a motor system for vehicles.

1. A motor driving device for a motor system, comprising:
at least one half bridge,
including a high-side transistor and a low-side transistor connected in series between an application end of a power supply voltage and an application end of ground potential, and
operable to connect a motor to a node to which the high-side transistor and the low-side transistor are connected;
a power relay, connected between the application end of the power supply voltage and the high-side transistor, and including one or more N-channel MOSFETs;
a motor relay, connected between the node and the motor, and including one or more N-channel MOSFETs; and
a booster circuit, operable to boost the power supply voltage to generate an output voltage,
wherein the motor driving device includes a control unit operable to output a gate signal to a gate of the motor relay, and
the gate signal is inputted to a power relay control unit operable to switch whether to apply the output voltage to a gate of the power relay.

2. The motor driving device of claim 1, wherein
the power relay control unit includes one or more gate cutoff relays connected between an application end of the output voltage and the gate of the power relay, and
the gate signal is applicable to a gate of the gate cutoff relay.

3. The motor driving device of claim 2, wherein the power relay control unit includes two or more of the gate cutoff relays connected in parallel.

4. The motor driving device of claim 2, comprising:
an output terminal, as an external terminal operable to output the output voltage, wherein a capacitor is connected between the output terminal and the application end of the power supply voltage, and the gate cutoff relay is externally connected to the output terminal.

5. The motor driving device of claim 4, wherein the booster circuit is a charging pump.

6. The motor driving device of claim 2, comprising:
an output terminal, as an external terminal,
wherein the power relay control unit is built into the motor driving device, and the gate cutoff relay is connected between an output end of the booster circuit and the output terminal.

7. The motor driving device of claim 1, comprising:
an output terminal, as an external terminal operable to output the output voltage, wherein the booster circuit is a charging pump, the booster circuit includes:
a first transistor and a second transistor connected between the output terminal and the application end of the power supply voltage; and
a third transistor including a diode connected in a direction opposite to an anti-parallel diode of the first transistor or the second transistor,
the power relay control unit includes a pull-down switch operable to pull down the output terminal to ground potential,
the power relay control unit is operable to switch between a first mode and a second mode according to the gate signal,
the first mode is a mode in which the pull-down switch is turned off, and the first transistor, the second transistor and the third transistor are turned on or off according to switching of a control signal, and
the second mode is a mode in which the pull-down switch is turned on, and the first transistor, the second transistor and the third transistor are turned off regardless of the control signal.

8. The motor driving device of claim 7, wherein
the first transistor includes a P-channel MOSFET,
the second transistor includes an N-channel MOSFET,
the third transistor includes an N-channel MOSFET, and
sources or drains of the second transistor and the third transistor are connected at same node.

9. The motor driving device of claim 7, wherein
the first transistor includes a P-channel MOSFET,
the second transistor includes an N-channel MOSFET,
the third transistor includes a P-channel MOSFET, and
sources or drains of the first transistor and the third transistor are connected at same node.

10. The motor driving device of claim 7, wherein
the motor relay is disposed in a number of two or more,
when at least one of the gate signals is at a high level, the power relay control unit is in the first mode, and
when all the gate signals are at a low level, the power relay control unit is in the second mode.

11. The motor driving device of claim 10, wherein when a selection signal is at a predetermined level, the power relay control unit enters the first mode regardless of the gate signal.

12. A motor system, comprising:
the motor driving device of claim 1;
the half bridge; and
the motor.

13. A vehicle, comprising the motor system of claim 12.
